(19) United States
(12) Patent Application Publication
(10) Pub. No.: US 2021/0400295 A1
(43) Pub. Date: Dec. 23, 2021

(54) NULL TILE CODING IN VIDEO CODING

(71) Applicant: ZTE Corporation, Shenzhen (CN)

(72) Inventors: Ming LI, Shenzhen (CN); Ping WU, Shenzhen (CN)

(21) Appl. No.: 17/468,435

(22) Filed: Sep. 7, 2021

Related U.S. Application Data
(63) Continuation of application No. PCT/CN2019/077549, filed on Mar. 8, 2019.

(51) Int. Cl. H04N 19/46; H04N 19/119; H04N 19/159; H04N 19/176

(52) U.S. Cl. CPC H04N 19/46; H04N 19/176; H04N 19/159; H04N 19/119

(57) ABSTRACT

A bitstream processing method includes parsing a bitstream to obtain a picture region flag from a data unit corresponding to a picture region in the bitstream, wherein the picture region includes N picture blocks, where N is an integer; and selectively generating, based on a value of the picture region flag, a decoded representation of the picture region from the bitstream. wherein The selectively generating includes in case that the value of the picture region flag is a first value, using a first decoding method to generate the decoded representation from the bitstream; and in case that the value of the picture region flag is a second value different than the first value, using a second decoding method different from the first decoding method to generate the decoded representation from the bitstream.

### CROSS-REFERENCE TO RELATED APPLICATIONS

This application is a continuation of International Patent Application No. PCT/CN2019/077549, filed on Mar. 8, 2019, the contents of which are incorporated herein by reference in their entirety.

### TECHNICAL FIELD

This patent document is directed generally to video and image encoding and decoding.

### BACKGROUND

Video encoding uses compression tools to encode two-dimensional video frames into a compressed bitstream representation that is more efficient for storing or transporting over a network. Traditional video coding techniques that use two-dimensional video frames for encoding sometimes are inefficient for representation of visual information of a three-dimensional visual scene.

### SUMMARY

This patent document describes, among other things, techniques for encoding and decoding digital video using null tile coding that may be used in some embodiments for coding or decoding immersive video.

This disclosure relates to video processing and communication, in particular to methods and apparatus for encoding a digital video or picture to generate a bitstream, methods and apparatus for decoding a bitstream to reconstruct a digital video or picture (visual information), methods and apparatus for extracting a bitstream to form a sub-bitstream.

In one example aspect, a method of bitstream processing is disclosed. The method includes parsing a bitstream to obtain a picture region flag from a data unit corresponding to a picture region in the bitstream, wherein the picture region includes N picture blocks, where N is an integer; and selectively generating, based on a value of the picture region flag, a decoded representation of the picture region from the bitstream. wherein The selectively generating includes in case that the value of the picture region flag is a first value, using a first decoding method to generate the decoded representation from the bitstream; and in case that the value of the picture region flag is a second value that is different from the first value, using a second decoding method different from the first decoding method to generate the decoded representation from the bitstream.

In another aspect, a method of visual information processing is disclosed. The method includes parsing a bitstream to obtain a picture region parameter from a parameter set data unit in the bitstream, wherein the picture region parameter indicates a partitioning of a picture into one or more picture regions; determining, according to a target picture region, one or more picture regions located in the target picture region; extracting one or more data units corresponding to the one or more picture regions located in the target picture region from the bitstream to form a sub-bitstream; generating a first data unit corresponding to an outside picture region that is outside the target picture region, and setting a picture region flag in the first data unit equal to a first value indicating that no bits are coded in the bitstream for a coding block in the outside picture region; and inserting the first data unit in the sub-bitstream.

In yet another example aspect, a video or picture coding method is disclosed. The method includes partitioning a picture into one or more picture regions, wherein a picture region contains N picture blocks, where N is an integer, selectively generating, based on a coding criterion, a bitstream from the N picture blocks. The selectively generating includes in case that the coding criterion is to code the picture region, coding a picture region flag corresponding to the picture region to a first value and coding picture blocks in the picture region using a first coding method (186), and in case that the coding criterion is to not code the picture region, then coding the picture region flag corresponding to the picture region to a second value and coding the picture region using a second coding method different from the first coding method

In another example aspect, an apparatus for processing one or more bitstreams of a video or picture is disclosed.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF DRAWINGS

FIG. 1A is a flowchart for an example method of bitstream processing.

FIG. 1B is a flowchart for an example method of visual information processing.

FIG. 1C is a flowchart for an example method of a method of processing video or pictures.

FIG. 2 is a diagram illustrating an example video or picture encoder that implements the methods in this disclosure.

FIG. 3 is a diagram illustrating an example of partitioning a picture into tile groups.

FIG. 4 is a diagram illustrating an example of partitioning a picture into tile groups.

FIG. 5 is a diagram illustrating an example of viewing 360 degree omnidirectional video.

FIG. 6 is a diagram illustrating an example of partitioning a picture into picture regions.

FIG. 7A-7B illustrate examples of syntax structure in a bitstream.

FIG. 8 is a diagram illustrating an example video or picture decoder that implements the methods in this disclosure.

FIG. 9 is a diagram illustrating an example of an extractor that implements the methods in this disclosure.

FIG. 10 is a diagram illustrating a first example device including at least the example encoder described in this disclosure.

FIG. 11 is a diagram illustrating a second example device including at least the example decoder described in this disclosure.

FIG. 12 is a diagram illustrating an electronic system including the first example device and the second example device.

FIG. 13A shows an example of group of tiles used for rendering is viewport.

FIG. 13B shows an example of reorganization of tiles for a frame-based compression.

FIG. 14 shows a hardware platform for implementing a technique described in the present document.

### DETAILED DESCRIPTION

Section headings are used in the present document only to improve readability and do not limit scope of the disclosed embodiments and techniques in each section to only that section. Certain features are described using the example of the H.264/AVC (advanced video coding), H.265/HEVC (high efficiency video coding) and H.266 Versatile Video Coding (VVC) standards. However, applicability of the disclosed techniques is not limited to only H.264/AVC or H.265/HEVC or H.266/VVC systems.

This disclosure relates to video processing and communication, in particular to methods and apparatus for encoding a digital video or picture to generate a bitstream, methods and apparatus for decoding a bitstream to reconstruct a digital video or picture.

### BRIEF DISCUSSION

Techniques for compressing digital video and picture utilizes correlation characteristics among pixel samples to remove redundancy in the video and picture. An encoder may partition a picture into one or more picture regions containing a number of units. Such picture region breaks prediction dependencies within a picture, so that a picture region can be decoded or at least syntax elements corresponding to this picture region can be correctly parsed without referencing to data of another picture region in the same picture. Such picture region introduced in video coding standards is to facilitate resynchronization after data losses, parallel processing, region of interesting coding and streaming, packetized transmission, viewport dependent streaming, and etc. Example of such picture region includes slice/slice group in H.264/AVC standard, slice/tile in H.265/HEVC standard and tile group/tile in H.266/VVC standard which is currently under development by JVET (Joint Video Experts Team of ITU-T SG 16 WP 3 and ISO/IEC JTC 1/SC 29/WG 11).

360 degree omnidirectional video provides immersive perceptual experience to viewers. A typical service using a 360 degree omnidirectional video is virtual reality (VR). Other service using such video includes augmented reality (AR), mixed reality (MR) and extended reality (XR). Take VR service for example. In the current applicable solution, 360 degree omnidirectional video in a form of sphere video is first projected to a regular video of rectangular pictures, which is then coded using an ordinary encoder (e.g. H.264/AVC or H.265/HEVC encoder) and transmitted via networks. At the destination, an ordinary decoder reconstructs the rectangle pictures for rendering by a displayer (e.g. a head mounted device, HMD). The most popular projection methods are ERP (Equal Rectangular Projection) and cubemap projection.

In order to save transmission bandwidth, viewport based streaming is developed. At the destination, a user device (e.g. an HMD) traces a direction which is focused to by a viewer, generates a current viewport information, and feedbacks the viewport information to a media server. The media server extracts a sub-bitstream covering only one or more picture regions for rendering the scene of the current viewport, and sends this sub-bitstream to the user device at the destination. From a perspective of video coding, such viewport based streaming can be carried out with the help of slice/slice group in H.264/AVC standard, slice/tile in H.265/HEVC standard and tile group/tile in H.266/VVC standard which is currently under development by JVET (Joint Video Experts Team of ITU-T SG 16 WP 3 and ISO/IEC JTC 1/SC 29/WG 11).

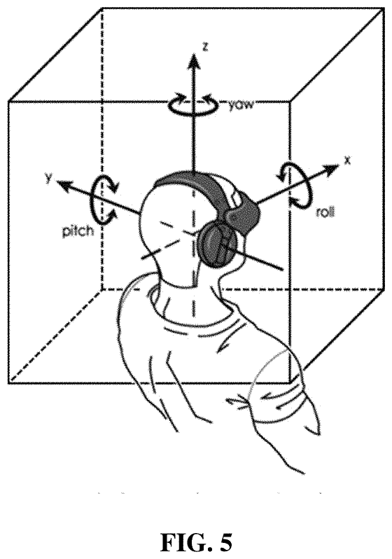

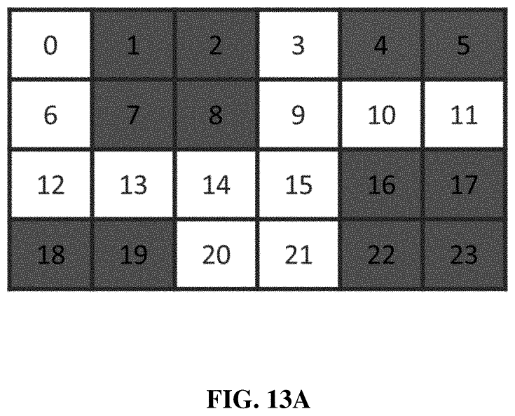

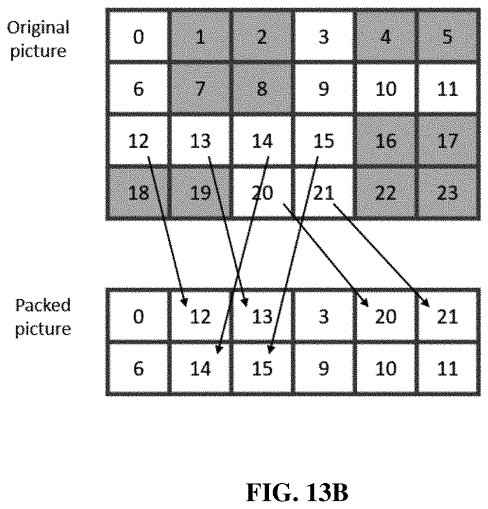

A general example of viewport based streaming is as follows. A 360 degree omnidirectional video is projected to a regular video using cubemap projection. A picture is partitioned into 24 tile groups or tiles in encoding. If a viewer is focusing on a field as illustrated in FIG. 5, 12 tile groups or tiles of the totally 24 tile groups or tiles are required in rendering, as shown in FIG. 13A. It is noted that FIG. 13A has been reproduced from MPEG contribution m46538.

Since the tile groups or tiles in FIG. 13A do not form a rectangular picture, a frame-based approach is employed to rearrange the locations of these tile groups or tiles to form a rectangular picture, as illustrated in FIG. 13B. A server extracts data units corresponding to the tile groups or tiles for rendering the viewport and organized such data units according to the formed rectangular picture to generate a sub-bitstream.

The drawbacks of the viewport based streaming using frame-based approach are as follows. In the original picture in FIG. 13B, locations of the tile groups or tiles correspond to faces of the cube of the used cubemap projection, which have explicit geometry mapping relationship to a region on a surface of a sphere of a 360 degree omnidirectional video for rendering. After rearranging by the frame-based approach, such mapping relationship is destroyed in the packed picture since not all the tile groups or tiles are following the grid of cube faces of the cubemap projection. A solution is that the server generates metadata specifying the rearranging locations and sends the metadata along with the sub-bitstream to the user device. The user device recovers the locations of the tile groups or tiles in the packed picture to the locations in the original picture, and then renders the region on the sphere face of the 360 degree omnidirectional video for viewing. Obviously, computational complexity increases in both server and user device, and metadata consumes extra transmission bandwidth and computational and storage resources of network middlewares.

Actually, the general problem is how to signal a picture region that is not represented in a video bitstream, for example, the dark regions in FIG. 13A or 13B.

Another application scenario is video surveillance, especially when high resolution video is employed in surveillance systems. Since the content in the background region does not change frequently or always keeps relatively constant, an actual focusing point is one or more picture regions with moving objects. Therefore, coding efficiency for surveillance video can be greatly improved by skip coding of background content, which requires signaling of a picture region that is not coded or skipped.

Embodiments of the present disclosure provide video or picture encoding and decoding methods, encoding and decoding devices, methods and apparatus for extracting a bitstream to form a sub-bitstream to at least solve problem of extra computational burden in bitstream extracting process and extractor.

According to an aspect of the embodiments of the present disclosure, there is provided an encoding method for processing video or picture, including:

partitioning a picture into one or more picture regions, wherein a picture region contains one or more coding blocks;

determining whether to code a picture region; if yes, coding a picture region flag corresponding to this picture region equal to a first value, and coding blocks in the picture region;

otherwise, coding the picture region flag equal to a second value, skipping coding the coding blocks in the picture region, and setting a value of a pixel in the picture region equal to a value of a co-located pixel in a reference picture of the picture region if the reference picture exists and the type of the picture region indicates inter prediction, or, setting a value of a pixel in the picture region equal to a value of a predetermined value if the reference picture does not exist or the type of the picture region indicates intra prediction.

According to an aspect of the embodiments of the present disclosure, there is provided a decoding method for processing a bitstream to reconstruct a video or picture, including:

parsing a bitstream to obtain a picture region flag from a data unit corresponding to the picture region in the bitstream;

if the picture region flag is equal to a first value, decoding one or more decoding blocks in the picture region;

otherwise, if the picture region flag is equal to a second value, setting a value of a pixel in the picture region equal to a value of a co-located pixel in a reference picture of the picture region if the reference picture exists and the type of the picture region indicates inter prediction, or, setting a value of a pixel in the picture region equal to a value of a predetermined value if the reference picture does not exist or the type of the picture region indicates intra prediction.

According to an aspect of the embodiments of the present disclosure, there is provided an extracting method for processing a bitstream to derive a sub-bitstream which can be decoded using the above presented decoding method, including:

parsing a bitstream to obtain a picture region parameter from a parameter set data unit in the bitstream, wherein the picture region parameter indicates a partitioning of a picture into one or more picture regions;

according to a target picture region, determining one or more picture regions located in the target picture region;

extracting one or more data units corresponding to the one or more picture regions located in the target picture region from the bitstream to form a sub-bitstream;

generating a first data unit corresponding to a picture region that is outside the target picture region, and setting a picture region flag in the first data unit equal to a first value indicating that no bits of a coding block in this picture region that is outside the target picture region exist;

inserting the first data unit in the sub-bitstream.

By means of the above methods, the problem of extra computational burden of viewport-based streaming in the related art is solved, and further achieved are the effects of effective coding a picture region that is skipped in coding.

In this disclosure, a video is composed of a sequence of one or more pictures. A bitstream, which is also referred to as a video elementary stream, is generated by an encoder processing a video or picture. A bitstream can also be a transport stream or media file that is an output of performing a system layer process on a video elementary stream generated by a video or picture encoder. Decoding a bitstream results in a video or a picture. The system layer process is to encapsulate a video elementary stream. For example, the video elementary stream is packed into a transport stream or media file as payloads. The system layer process also includes operations of encapsulating transport stream or media file into a stream for transmission or a file for storage as payloads. A data unit generated in the system layer process is referred to as a system layer data unit. Information attached in a system layer data unit during encapsulating a payload in the system layer process is called system layer information, for example, a header of a system layer data unit. Extracting a bitstream obtains a sub-bitstream containing a part of bits of the bitstream as well as one or more necessary modifications on syntax elements by the extraction process. Decoding a sub-bitstream results in a video or a picture, which, compared to the video or picture obtained by decoding the bitstream, may be of lower resolution and/or of lower frame rate. A video or a picture obtained from a sub-bitstream could also be a region of the video or picture obtained from the bitstream.

### Embodiment 1

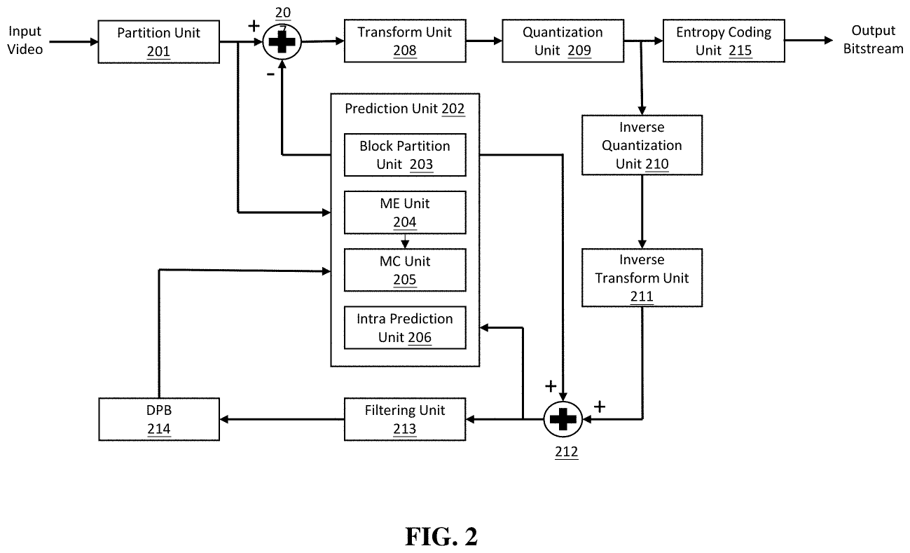

FIG. 2 is a diagram illustrating an encoder utilizing the method in this disclosure in coding a video or a picture. An input of the encoder is a video, and an output is a bitstream. As the video is composed of a sequence of pictures, the encoder processes the pictures one by one in a preset order, i.e. an encoding order. The encoder order is determined according to a prediction structure specified in a configuration file for the encoder. Note that an encoding order of pictures in a video (corresponding to a decoding order of pictures at a decoder end) may be identical to, or may be different from, a displaying order of the pictures.

Partition Unit 201 partitions a picture in an input video according to a configuration of the encoder. Generally, a picture can be partitioned into one or more maximum coding blocks. Maximum coding block is the maximum allowed or configured block in encoding process and usually a square region in a picture. A picture can be partitioned into one more tiles, and a tile may contain an integer number of maximum coding blocks, or a non-integer number of maximum coding blocks. One option is a tile may contain one or more slices. That is, a tile can further be partitioned into one or more slices, and each slice may contain an integer number of maximum coding blocks, or a non-integer number of maximum coding blocks. Another option is a slice contains one or more tiles, or, a tile group contains one or more tiles. That is, one or more tiles in a certain order in the picture (e.g. raster scan order of tiles) forms a tile group. In addition, a tile group can also cover a rectangle region in a picture represented with the locations of the up-left tile and bottom-right tile. In the following descriptions, “tile group” is used as an example. Partition unit 201 can be configured to partition a picture using a fixed pattern. For example, partition unit 201 partitions a picture into tile groups, and each tile group has a single tile containing a row of maximum coding blocks. Another example is that partition unit 201 partitions a picture into multiple tiles and forms tiles in raster scan order in the picture into tile groups. Alternatively, partition unit 201 can also employ a dynamic pattern to partition the picture into tile group, tile and blocks. For example, to adapt to the restriction of maximum transmission unit (MTU) size, partition unit 201 employs dynamic tile group partitioning method to ensure that a number of coding bits of every tile group does not exceed MTU restriction.

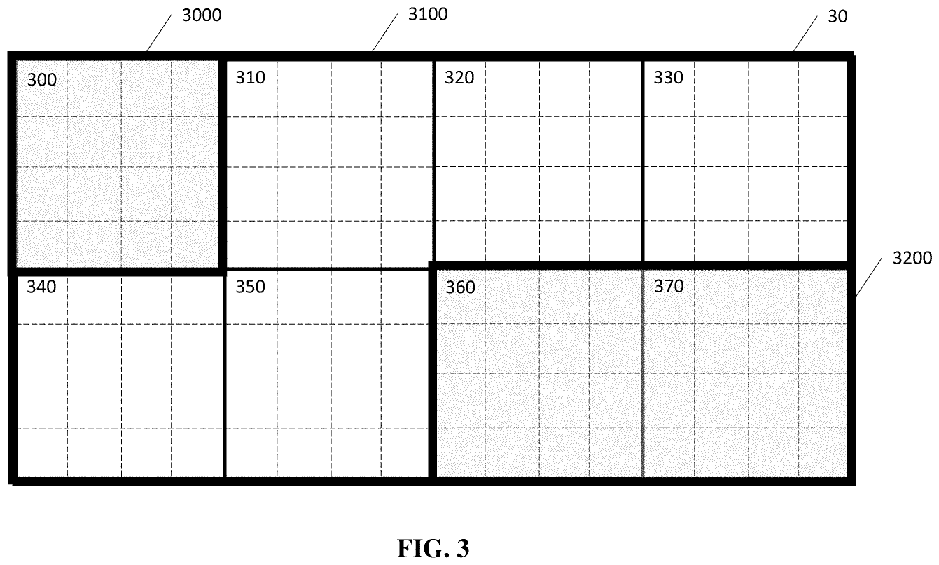

FIG. 3 is a diagram illustrating an example of partitioning a picture into tile groups. Partition unit 201 partitions a picture 30 with 16 by 8 maximum coding blocks (depicted in dash lines) into 8 tiles 300, 310, 320, 330, 340, 350, 360 and 370. Partition unit 201 partitions picture 30 into 3 tile groups. Tile group 3000 contains tile 300, tile group 3100 contains tiles 310, 320, 330, 340, and 350, tile group 3200 contains tiles 360 and 370. Tile groups in FIG. 3 are formed in tile raster scan order in picture 30.

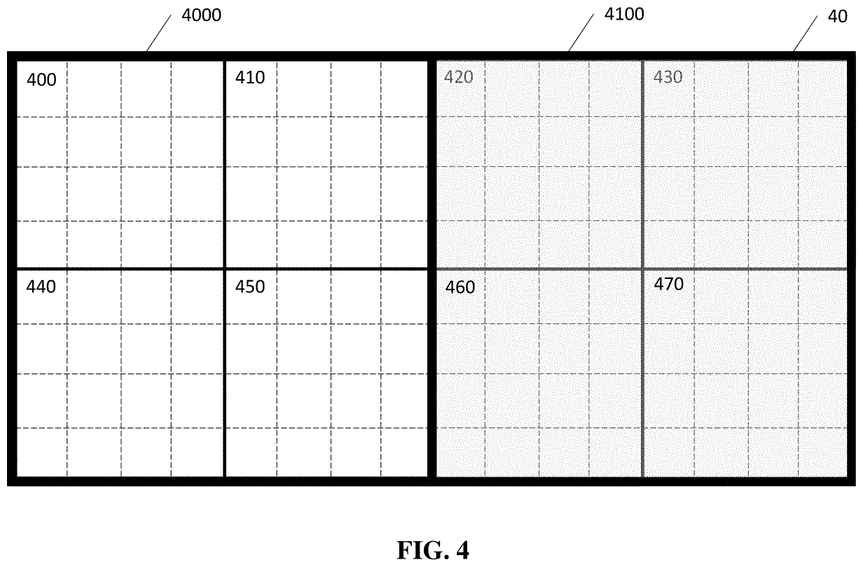

FIG. 4 is a diagram illustrating an example of partitioning a picture into tile groups. Partition unit 201 partitions a picture 40 with 16 by 8 maximum coding blocks (depicted in dash lines) into 8 tiles 400, 410, 420, 430, 440, 450, 460 and 470. Partition unit 201 partitions picture 40 into 2 tile groups. Tile group 4000 contains tile 400, 410, 440 and 450, tile group 4100 contains tiles 420, 430, 460, and 470. Tile group 4000 is represented as up-left tile 400 and bottom-right tile 450, and tile group 4100 as up-left tile 420 and bottom-right tile 470.

One or more tile groups or tiles can be referred as a picture region. Generally, partitioning a picture into one or more tiles is conducted according to an encoder configuration file. Partition unit 201 sets a partitioning parameter to indicate a partitioning manner of the picture into tiles. For example, a partitioning manner can be to partition the picture into tiles of (nearly) equal sizes. Another example is that a partitioning manner may indicate locations of tile boundaries in rows and/or columns to facilitate flexible partitioning.

Output parameters of partition unit 201 indicates a partitioning manner of a picture.

Prediction unit 202 determines prediction samples of a coding block in a picture region. Prediction unit 202 includes block partition unit 203, ME (Motion Estimation) unit 204, MC (Motion Compensation) unit 205 and intra prediction unit 206. An input of the prediction unit 202 is a picture region containing one or more maximum coding blocks outputted by partition unit 201 and attribute parameters associated with a maximum coding block, for example, location of the maximum coding block in a picture and in the picture region. Prediction unit 202 partitions the maximum coding block into one or more coding blocks, which can also be further partitioned into smaller coding blocks. One or more partitioning method can be applied including quadtree, binary split and ternary split. Prediction unit 202 determines prediction samples for coding block obtained in partitioning. Optionally, prediction unit 202 can further partition a coding block into one or more prediction blocks to determine prediction samples. Prediction unit 202 employs one or more pictures in DPB (Decoded Picture Buffer) unit 214 as reference to determine inter prediction samples of the coding block. Prediction unit 202 can also employs reconstructed parts of the picture outputted by adder 212 as reference to derive prediction samples of the coding block. Prediction unit 202 determines prediction samples of the coding block and associated parameters for deriving the prediction samples, which are also output parameters of prediction unit 202, by, for example, using general rate-distortion optimization (RDO) methods.

Prediction unit 202 also determines whether to skip coding the picture region or not. When prediction unit 202 determines not to skip coding the picture region, prediction unit 202 sets a picture region flag equal to a first value. Otherwise, when prediction unit 202 determines to skip coding the picture region, prediction unit 202 sets the picture region flag equal to a second value, and prediction unit 202, as well as other related units in the encoder, such as transform unit 208, quantization unit 209, inverse quantization unit 210 and inverse transform unit 211, does not invoke a process of coding the coding blocks in the picture region. In the case that the picture region flag is equal to the second value, prediction unit 202 sets a value of a pixel in the picture region equal to a value of a co-located pixel in a reference picture of the picture region if the reference picture exists and a type of the picture region indicates inter prediction, or setting a value of a pixel in the picture region equal to a value of a predetermined value if the reference picture does not exist or the type of the picture region indicates intra prediction. The reference picture can be the first picture in a reference picture list, for example, a picture indicated by a reference index equal to 0 in reference list 0. Optionally, the reference picture can also be a picture in a reference list with the smallest POC (Picture Order Count) difference between a current coding picture containing the picture region. Optionally, the reference picture can be a picture selected by prediction unit 202 (e.g. using general RDO methods) from pictures in a reference list, and prediction unit 202 needs to output a reference index to be coded in a bitstream by entropy coding unit 215. The predetermined value can be a fixed value burned in both encoder and decoder, or calculated as 1<<(bitDepth−1), wherein bitDepth is a value of bit depth of a pixel sample component, “<<” is an arithmetic left shifting operator and “x<<y” means arithmetic left shift of a two's complement integer representation of x by y binary digits. Optionally, prediction unit 202 can set a value in the picture region equal to a predetermined value regardless of whether reference picture for this picture region exist or not. When the picture region flag equal to the second value, the prediction residual of coding blocks in the picture region are set to 0. That is, when the picture region flag equal to the second value, the value of reconstructed pixel in the picture region is set equal to its prediction value derived by prediction unit 202.

Prediction unit 202 can use general RDO methods to determine to whether to skip coding a picture region or not. For example, when prediction unit 202 finds that the accumulated value of a cost function in RDO counting all the coding blocks in this picture region is not larger than the value of the cost function in RDO counting skipping coding the picture region, prediction unit 202 determines the picture region flag to the first value; otherwise, to the second value.

Optionally, prediction unit 202 can also determine the picture region flag value according to an encoder configuration. An example scenario is in video surveillance, especially when high resolution video is employed in surveillance systems. Since the content in the background region does not change frequently or always keeps relatively constant, an actual focusing point is one or more picture regions with moving objects, e.g. using existing motion detection methods and algorithms. Therefore, when it is determined that the picture region contains at least a part of moving object in the scene, prediction unit 202 sets the picture region flag corresponding to this picture region equal to the first value; otherwise prediction unit 202 sets the picture region flag equal to the second value.

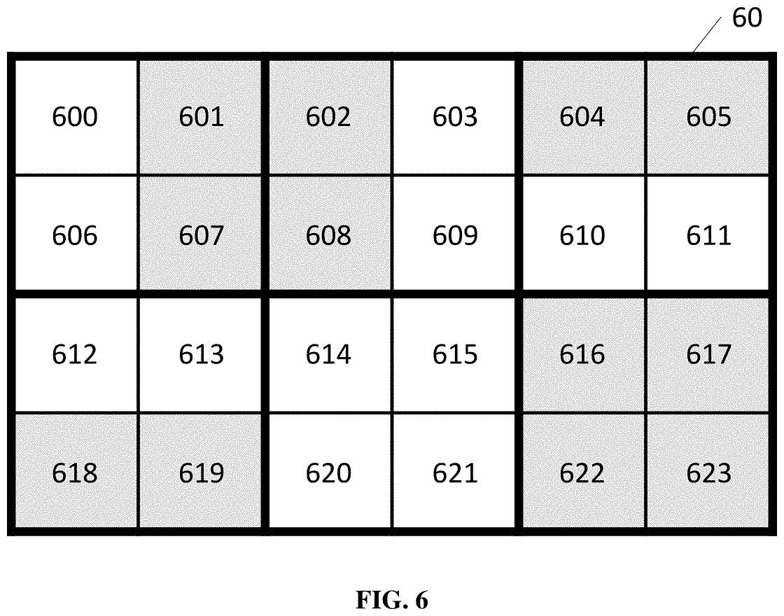

Another example is in communication using 360-degree omnidirection video, e.g. video telephony, video conference, video chatting, remote controlling or etc. FIG. 5 is a diagram illustrating an example of viewing 360-degree omnidirectional video. A viewer in FIG. 5 views a 360-degree omnidirectional video coded using cubemap projection. FIG. 6 is a diagram illustrating an example of partitioning a picture into picture regions. Picture 60 is partitioned into 24 picture regions, wherein a picture region can be a tile group or a tile. Picture regions 600, 601, 606 and 607 correspond to a first surface of cubemap, 602, 603, 608 and 609 correspond to a second surface, 604, 605, 610 and 611 correspond to a third surface, 612, 613, 618 and 619 correspond to a fourth surface, 614, 615, 620 and 621 correspond to a fifth surface, and 616, 617, 622 and 623 correspond to a sixth surface. To rendering a content at a viewport illustrated in FIG. 5, picture regions 600, 603, 606, 609, 610, 611, 612, 613, 614, 615, 620 and 621 will be employed for rendering, while the other picture regions (marked in gray in FIG. 6) are not required for rendering. Prediction unit 201 sets the picture region flags corresponding to the picture regions marked in gray in FIG. 6 equal to the second value. Prediction unit 201 can directly set the prediction region flags corresponding to the picture regions for rendering equal to the first value, or invoke the general RDO method to determine the prediction region flags.

Output of prediction unit 202 includes the picture region flag. Prediction value of pixels in a picture region and other necessary parameters associated with the prediction region flag (e.g. reference index indicating a reference picture for prediction samples) are also in the output of prediction unit 202.

Inside prediction unit 202, block partition unit 203 determines the partitioning of the coding block. Block partition unit 203 partitions the maximum coding block into one or more coding blocks, which can also be further partitioned into smaller coding blocks. One or more partitioning method can be applied including quadtree, binary split and ternary split. Optionally, block partition unit 203 can further partition a coding block into one or more prediction blocks to determine prediction samples. Block partition unit 203 can adopt RDO methods in the determination of partitioning of the coding block. Output parameters of block partition unit 203 includes one or more parameters indicating the partitioning of the coding block.

ME unit 204 and MC unit 205 utilize one or more decoded pictures from DPB 214 as reference picture to determine inter prediction samples of a coding block. ME unit 204 constructs one or more reference lists containing one or more reference pictures and determines one or more matching blocks in reference picture for the coding block. MC unit 205 derives prediction samples using the samples in the matching block, and calculates a difference (i.e. residual) between original samples in the coding block and the prediction samples. Output parameters of ME unit 204 indicate location of matching block including reference list index, reference index (refIdx), motion vector (MV) and etc., wherein reference list index indicates the reference list containing the reference picture in which the matching block locates, reference index indicates the reference picture in the reference list containing the matching block, and MV indicates the relative offset between the locations of the coding block and the matching block in an identical coordinate for representing locations of pixels in a picture. Output parameters of MC unit 205 are inter prediction samples of the coding block, as well as parameters for constructing the inter prediction samples, for example, weighting parameters for samples in the matching block, filter type and parameters for filtering samples in the matching block. Generally, RDO methods can be applied jointly to ME unit 204 and MC unit 205 for getting optimal matching block in rate-distortion (RD) sense and corresponding output parameters of the two units.

Specially and optionally, ME unit 204 and MC unit 205 can use the current picture containing the coding block as reference to obtain intra prediction samples of the coding block. In this disclosure, by intra prediction is meant that only the data in a picture containing a coding block is employed as reference for derive prediction samples of the coding block. In this case, ME unit 204 and MC unit 205 use reconstructed part in the current picture, wherein the reconstructed part is from the output of adder 212. An example is that the encoder allocates a picture buffer to (temporally) store output data of adder 212. Another method for the encoder is to reserve a special picture buffer in DPB 214 to keep the data from adder 212.

Intra prediction unit 206 use reconstructed part of the current picture containing the coding block as reference to obtain intra prediction samples of the coding block. Intra prediction unit 206 takes reconstructed neighboring samples of the coding block as input of a filter for deriving intra prediction samples of the coding block, wherein the filter can be an interpolation filter (e.g. for calculating prediction samples when using angular intra prediction), a low-pass filter (e.g. for calculating DC value), or cross-component filters to derive a prediction value of a (color) component using already coded (color) component. Specially, intra prediction unit 206 can perform searching operations to get a matching block of the coding block in a range of reconstructed part in the current picture, and set samples in the matching block as intra prediction samples of the coding block. Intra prediction unit 206 invokes RDO methods to determine an intra prediction mode (i.e. a method for calculating intra prediction samples for a coding block) and corresponding prediction samples. Besides intra prediction samples, output of intra prediction unit 206 also includes one or more parameters indicating an intra prediction mode in use.

Adder 207 is configured to calculate difference between original samples and prediction samples of a coding block. Output of adder 207 is residual of the coding block. The residual can be represented as an N×M 2-dimensional matrix, wherein N and M are two positive integers, and N and M can be of equal or different values.

Transform unit 208 takes the residual as its input. Transform unit 208 may apply one or more transform methods to the residual. From the perspective of signal processing, a transform method can be represented by a transform matrix. Optionally, transform unit 208 may determine to use a rectangle block (in this disclosure, square block is a special case of a rectangle block) with the same shape and size as that of the coding block to be a transform block for the residual. Optionally, transform unit 208 may determine to partition the residual into several rectangle blocks (may also including a special case that width or height of a rectangle block is one sample) and the perform transform operations on the several rectangle sequentially, for example, according to a default order (e.g. raster scan order), a predefined order (e.g. an order corresponding to a prediction mode or a transform method), a selected order for several candidate orders. Transform unit 208 may determine to perform multiple transforms on the residual. For example, transform unit 208 first perform a core transform on the residual, and then perform a secondary transform on coefficients obtained after finishing the core transform. Transform unit 208 may utilize RDO methods to determine transform parameter, which indicates execution manners used in transform process applied to the residual block, for example, partitioning of the residual block into transform blocks, transform matrix, multiple transforms, and etc. The transform parameter is included in output parameters of transform unit 208. Output parameters of transform unit 208 includes the transform parameter and data obtained after transforming the residual (e.g. transform coefficients) which could be represented by a 2-dimensional matrix.

Quantization unit 209 quantizes the data outputted by transform unit 208 after its transforming the residual. Quantizer used in quantization unit 209 can be one or both of scalar quantizer and vector quantizer. In most video encoders, quantization unit 209 employs scalar quantizer. Quantization step of a scalar quantizer is represented by quantization parameter (QP) in a video encoder. Generally, identical mapping between QP and quantization step is preset or predefined in an encoder and a corresponding decoder.

A value of QP, for example, picture level QP and/or block level QP, can be set according to a configuration file applied to an encoder, or be determined by a coder control unit in an encoder. For example, the coder control unit determines a quantization step of a picture and/or a block using rate control (RC) methods and then converts the quantization step into QP according to the mapping between QP and quantization step.

Control parameter for quantization unit 209 is QP. Output of quantization unit 209 is one or more quantized transform coefficients (i.e. known as “Level”) represented in a form of a 2-dimensional matrix.

Inverse quantization 210 performs scaling operations on output of quantization 209 to get reconstructed coefficients. Inverse transform unit 211 performs inverse transform on the reconstructed coefficients from inverse quantization 210 according to the transform parameter from transform unit 208. Output of inverse transform unit 211 is reconstructed residual. Specially, when an encoder determines to skip quantizing in coding a block (e.g. an encoder implements RDO methods to determine whether applying quantization to a coding block), the encoder guides the output data of transform unit 208 to inverse transform unit 211 by bypassing quantization unit 209 and inverse quantization 210.

Adder 212 takes the reconstructed residual and prediction samples of the coding block from prediction unit 202 as input, calculates reconstructed samples of the coding block, and put the reconstructed samples into a buffer (e.g. a picture buffer). For example, the encoder allocates a picture buffer to (temporally) store output data of adder 212. Another method for the encoder is to reserve a special picture buffer in DPB 214 to keep the data from adder 212.

Filtering unit 213 performs filtering operations on reconstructed picture samples in decoded picture buffer and outputs decoded pictures. Filtering unit 213 may consist of one filter or several cascading filters. For example, according to H.265/HEVC standard, filtering unit is composed of two cascading filters, i.e. deblocking filter and sample adaptive offset (SAO) filter. Filtering unit 213 may include adaptive loop filter (ALF). Filtering unit 213 may also include neural network filters. Filtering unit 213 may start filtering reconstructed samples of a picture when reconstructed samples of all coding blocks in the picture have been stored in decoded picture buffer, which can be referred to as “picture layer filtering”. Optionally, an alternative implementation (referred to as “block layer filtering”) of picture layer filtering for filtering unit 213 is to start filtering reconstructed samples of a coding block in a picture if the reconstructed samples are not used as reference in encoding all successive coding blocks in the picture. Block layer filtering does not require filtering unit 213 to hold filtering operations until all reconstructed samples of a picture are available, and thus saves time delay among threads in an encoder. Filtering unit 213 determines filtering parameter by invoking RDO methods. Output of filtering unit 213 is decoded samples of a picture and filtering parameter including indication information of filter, filter coefficients, filter control parameter and etc.

The encoder stores the decoded picture from filtering unit 213 in DPB 214. The encoder may determine one or more instructions applied to DPB 214, which are used to control operations on pictures in DPB 214, for example, the time length of a picture storing in DPB 214, outputting a picture from DPB 214, and etc. In this disclosure, such instructions are taken as output parameter of DPB 214.

Entropy coding unit 215 performs binarization and entropy coding on one or more coding parameters of a picture, which converts a value of a coding parameter into a code word consisting of binary symbol “0” and “1” and writes the code word into a bitstream according to a specification or a standard. The coding parameters may be classified as texture data and non-texture. Texture data are transform coefficients of a coding block, and non-texture data are the other data in the coding parameters except texture data, including output parameters of the units in the encoder, parameter set, header, supplemental information, and etc. Output of entropy coding unit 215 is a bitstream conforming to a specification or a standard.

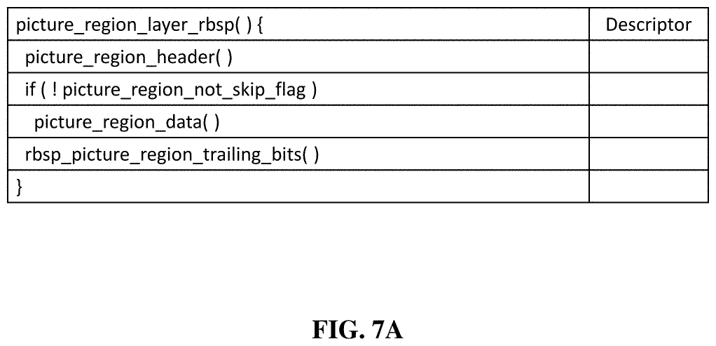

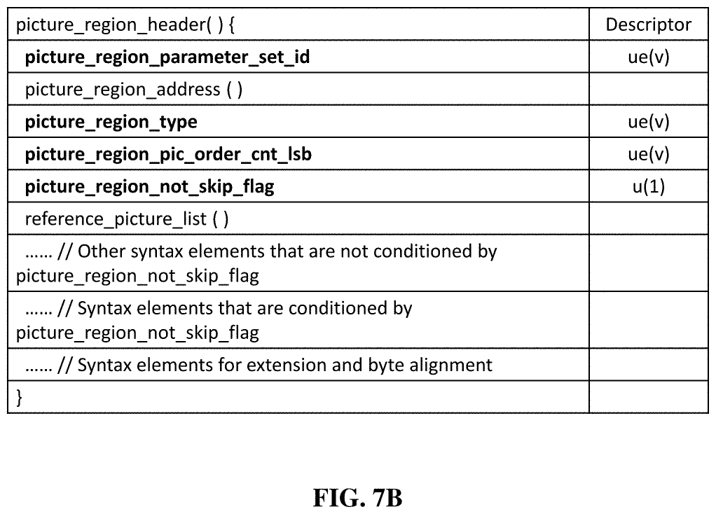

Entropy coding unit 215 codes the prediction region flag in the output of prediction unit 202. Entropy coding unit 215 codes the prediction region flag and writes its coding bit in a data unit containing a header of a picture region. FIG. 7A-7B illustrate examples of syntax structure in a bitstream, wherein a syntax in bold in FIG. 7A-7B is a syntax element represented by a string of one or more bits existing in the bitstream, and u(1) and ue(v) are two decoding method with the same function as that in published standards like H.264/AVC and H.265/HEVC. In this disclosure, a picture region can be a tile group, a tile, a slice or a slice group. Entropy coding unit 215 codes the prediction region flag (i.e. picture_region_not_skip_flag in FIG. 7A-7B), as well as other syntax elements that are conditioned by picture_region_not_skip_flag according to the value of picture_region_not_skip_flag. Also note that there are some syntax elements in FIG. 7A-7B that are coded independent of the value of picture_region_not_skip_flag.

In FIG. 7A, picture_region_layer_rbsp( ) is a data unit containing coding bits of a picture region. picture_region_header( ) is a header of the picture region. The picture region flag, picture_region_not_skip_flag, is coded in picture_region_header( ) picture_region_data( ) contains coding bits of coding blocks in the picture. In this example, when picture_region_not_skip_flag is equal to a second value (e.g. “0”), picture_region_data( ) is not presented in picture_region_layer_rbsp( ). For example, when the encoder determines a value of picture_region_not_skip_flag is equal to 1, the encoder codes the coding blocks in the picture region and entropy coding unit 215 writes one or more coding bits of the coding blocks into bitstream; otherwise, when the encoder determines a value of picture_region_not_skip_flag is equal to 0, the encoder skips coding the coding blocks in the picture region and entropy coding unit 215 skips writing a coding bit of the coding blocks into the bitstream.

In FIG. 7B, semantics of syntax elements in picture region header are as follows.

picture_region_parameter_set_id specifies the value of a parameter set identifier for the parameter set in use.

picture_region_address( ) contains syntax element representing the address of the picture region. For example, picture_region_address can be the address of the first coding block in the picture region. Also, if the picture region is a tile group, picture_region_address can be the tile address of the first tile in the tile group.

picture_region_type specifies the coding type of the picture region.

For example, picture_region_type equal to 0 indicates a “B” picture region, picture_region_type equal to 1 indicates a “P” picture region, and picture_region_type equal to 2 indicates an “I” picture region, wherein “B”, “P” and “I” represent the same meaning as those in H.264/AVC and H.265/HEVC.

picture_region_pic_order_cnt_lsb specifies the picture order count modulo MaxPicOrderCntLsb for the current picture.

picture_region_not_skip_flag equal to 0 specifies the picture region is skipped. picture_region_not_skip_flag equal to 1 specifies the picture region is not skipped.

When picture_region_not_skip_flag is equal to 0, bits of the coding blocks in this picture region are not presented in the bitstream. The reconstructed values of the coding blocks in this picture region are set equal to corresponding prediction values derived by prediction unit 202.

reference_picture_list( ) contains syntax elements for deriving reference list of the picture region.

The reference picture may be used to derive the prediction values by prediction unit 202 when picture_region_not_skip_flag equal to 0. If prediction unit 202 adopts the method that prediction value for a picture region with picture_region_not_skip_flag equal to 0 is set to a fixed value or a predetermined value, reference_picture_list( ) does not exist in the syntax structure when picture_not_skip_flag equal to 0.

### Embodiment 2

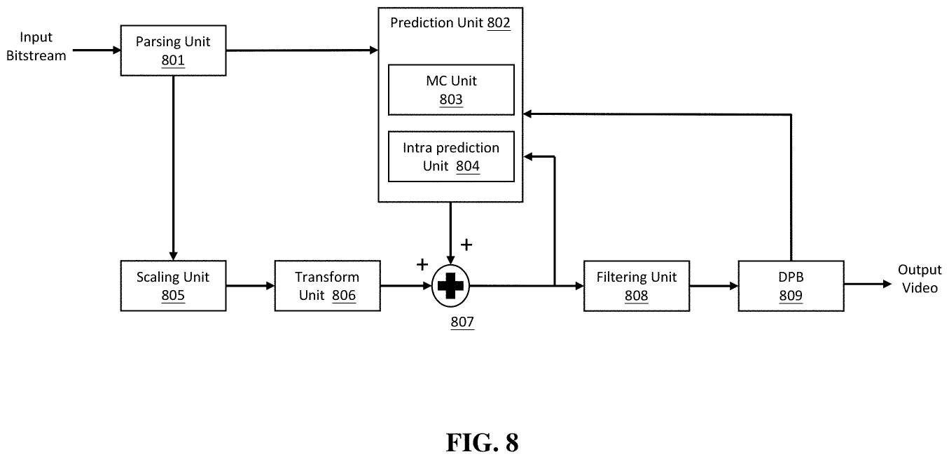

FIG. 8 is a diagram illustrating a decoder utilizing the method in this disclosure in decoding a bitstream generated by the aforementioned encoder in embodiment 1. Input of the decoder is a bitstream, and output of the decoder is decoded video or picture obtained by decoding the bitstream.

Parsing unit 801 in the decoder parses the input bitstream. Parsing unit 801 uses entropy decoding methods and binarization methods specified in a standard to convert each code word in the bitstream consisting of one or more binary symbols (i.e. “0” and “1”) to a numerical value of a corresponding parameter. Parsing unit 801 also derives parameter value according to one or more available parameters. For example, when there would be a flag in the bitstream indicating a decoding block is the first one in a picture, parsing unit 801 setting an address parameter, which indicates an address of the first decoding block of a picture region, to be 0.

In the input bitstream of parsing unit 801, the syntax structures for a picture region is illustrated in FIG. 7A-7B.

FIG. 7A-7B is a diagram illustrating examples of syntax structure in a bitstream, wherein a syntax in bold in FIG. 7A-7B is a syntax element represented by a string of one or more bits existing in the bitstream, and u(1) and ue(v) are two decoding method with the same function as that in published standards like H.264/AVC and H.265/HEVC. In this disclosure, a picture region can be a tile group, a tile, a slice or a slice group. Parsing unit 801 obtains a prediction region flag (i.e. picture_region_not_skip_flag in FIG. 7A-7B), as well as other syntax elements that are conditioned by picture_region_not_skip_flag according to the value of picture_region_not_skip_flag. Also note that there are some syntax elements in FIG. 7A-7B that are coded independent of the value of picture_region_not_skip_flag.

In FIG. 7A, picture_region_layer_rbsp( ) is a data unit containing coding bits of a picture region. picture_region_header( ) is a header of the picture region. The picture region flag, picture_region_not_skip_flag, is in picture_region_header( ) picture_region_data( ) contains coding bits of coding blocks in the picture. In this example, when picture_region_not_skip_flag is equal to a second value (e.g. “0”), picture_region_data( ) is not presented in picture_region_layer_rbsp( ).

In FIG. 7B, semantics of syntax elements in picture region header are as follows.

picture_region_parameter_set_id specifies the value of a parameter set identifier for the parameter set in use.

picture_region_address( ) contains syntax element representing the address of the picture region. For example, picture_region_address can be the address of the first coding block in the picture region. Also, if the picture region is a tile group, picture_region_address can be the tile address of the first tile in the tile group.

picture_region_type specifies the coding type of the picture region.

For example, picture_region_type equal to 0 indicates a “B” picture region, picture_region_type equal to 1 indicates a “P” picture region, and picture_region_type equal to 2 indicates an “I” picture region, wherein “B”, “P” and “I” represent the same meaning as those in H.264/AVC and H.265/HEVC.

picture_region_pic_order_cnt_lsb specifies the picture order count modulo MaxPicOrderCntLsb for the current picture.

picture_region_not_skip_flag equal to 0 specifies the picture region is skipped. picture_region_not_skip_flag equal to 1 specifies the picture region is not skipped.

When picture_region_not_skip_flag is equal to 0, bits of the coding blocks in this picture region are not presented in the bitstream. The reconstructed values of the coding blocks in this picture region are set equal to corresponding prediction values derived by prediction unit 802.

reference_picture_list( ) contains syntax elements for deriving reference list of the picture region.

The reference picture may be used to derive the prediction values by prediction unit 802 when picture_region_not_skip_flag equal to 0. If prediction unit 802 adopts the method that prediction value for a picture region with picture_region_not_skip_flag equal to 0 is set to a fixed value or a predetermined value, reference_picture_list( ) does not exist in the syntax structure when picture_not_skip_flag equal to 0.

Parsing unit 801 passes the picture region flag (i.e. picture_region_not_skip_flag) of the picture region to the other units in a decoder to decode the picture region.

Parsing unit 801 passes one or more prediction parameters for deriving prediction samples of a decoding block to prediction unit 802. In this disclosure, the prediction parameters include output parameters of partitioning unit 201 and prediction unit 202 in the aforementioned encoder.

Parsing unit 801 passes one or more residual parameters for reconstructing residual of a decoding block to scaling unit 805 and transform unit 806. In this disclosure, the residual parameters include output parameters of transform unit 208 and quantization unit 209 and one or more quantized coefficients (i.e. “Levels”) outputted by quantization unit 209 in the aforementioned encoder.

Parsing unit 801 passes filtering parameter to filtering unit 808 for filtering (e.g. in-loop filtering) reconstructed samples in a picture.

Prediction unit 802 derives prediction samples of a decoding block in a picture region according to the prediction parameters. Prediction unit 802 is composed of MC unit 803 and intra prediction unit 804. Input of prediction unit 802 may also include reconstructed part of a current decoding picture outputted from adder 807 (which is not processed by filtering unit 808) and one or more decoded pictures in DPB 809. When the picture region flag (i.e. picture_region_not_skip_flag) of the picture region is equal to the first value (i.e. “1”), prediction unit 802, as well as other related units in the decoder, such as scaling unit 805, transform unit 806, invokes a process of decoding the decoding blocks in the picture region. in the picture region.

When the picture region flag (i.e. picture_region_not_skip_flag) of the picture region is equal to the second value (i.e. “0”), prediction unit 802 sets a value of a pixel in the picture region equal to a value of a colocated pixel in a reference picture of the picture region if the reference picture exists and a type of the picture region indicates inter prediction (that is, picture_region_type equal to “B” or “P”), or setting a value of a pixel in the picture region equal to a value of a predetermined value if the reference picture does not exist (e.g. the first picture of a coded video sequence in decoding order) or the type of the picture region indicates intra prediction (that is, picture_region_type equal to “I”). The reference picture can be the first picture in a reference picture list, for example, a picture indicated by a reference index equal to 0 in reference list 0. Optionally, the reference picture can also be a picture in a reference list with the smallest POC (Picture Order Count) difference between a current coding picture containing the picture region. Optionally, the reference picture can be a picture indicated by a reference index in a reference list, wherein the reference index is obtained by parsing unit 801 by parsing bits in a data unit containing coding bits of this picture region in the bitstream. The predetermined value can be a fixed value burned in both encoder and decoder, or calculated as 1<<(bitDepth−1), wherein bitDepth is a value of bit depth of a pixel sample component, “<<” is an arithmetic left shifting operator and “x<<y” means arithmetic left shift of a two's complement integer representation of x by y binary digits. Optionally, prediction unit 802 can set a value in the picture region equal to a predetermined value regardless of whether reference picture for this picture region exist or not. When the picture region flag equal to the second value (i.e. picture_region_not_skip_flag), the prediction residual of coding blocks in the picture region are set to 0. That is, when the picture region flag equal to the second value (i.e. picture_region_not_skip_flag), the value of reconstructed pixel in the picture region is set equal to its prediction value derived by prediction unit 802, and scaling unit 805, transform unit 806 are not invoked by the decoder in a process of decoding the decoding blocks in the picture region. in the picture region.

When the prediction parameters indicate inter prediction mode is used to derive prediction samples of the decoding block, prediction unit 802 employs the same approach as that for ME unit 204 in the aforementioned encoder to construct one or more reference picture lists. A reference list contains one or more reference pictures from DPB 809. MC unit 803 determines one or more matching blocks for the decoding block according to indication of reference list, reference index and MV in the prediction parameters, and uses the same method as that in MC unit 205 in the aforementioned encoder to get inter prediction samples of the decoding block. Prediction unit 802 outputs the inter prediction samples as the prediction samples of the decoding block.

Specially and optionally, MC unit 803 may use the current decoding picture containing the decoding block as reference to obtain intra prediction samples of the decoding block. In this disclosure, by intra prediction is meant that only the data in a picture containing a coding block is employed as reference for derive prediction samples of the coding block. In this case, MC unit 803 use reconstructed part in the current picture, wherein the reconstructed part is from the output of adder 807 and is not processed by filtering unit 808. For example, the decoder allocates a picture buffer to (temporally) store output data of adder 807. Another method for the decoder is to reserve a special picture buffer in DPB 809 to keep the data from adder 807.

When the prediction parameters indicate intra prediction mode is used to derive prediction samples of the decoding block, prediction unit 802 employs the same approach as that for intra prediction unit 206 in the aforementioned encoder to determine reference samples for intra prediction unit 804 from reconstructed neighboring samples of the decoding block. Intra prediction unit 804 gets an intra prediction mode (i.e. DC mode, Planar mode, or an angular prediction mode) and derives intra prediction samples of the decoding block using reference samples following specified process of the intra prediction mode. Note that identical derivation process of an intra prediction mode is implemented in the aforementioned encoder (i.e. intra prediction unit 206) and the decoder (i.e. intra prediction unit 804). Specially, if the prediction parameters indicate a matching block (including its location) in the current decoding picture (which contains the decoding block) for the decoding block, intra prediction unit 804 use samples in the matching block to derive the intra prediction samples of the decoding block. For example, intra prediction unit 804 sets intra prediction samples equal to the samples in the matching block. Prediction unit 802 sets prediction samples of the decoding block equal to intra prediction samples outputted by intra prediction unit 804.

The decoder passes QP, including luma QP and chroma QP, and quantized coefficients to scaling unit 805 for process of inverse quantization to get reconstructed coefficients as output. The decoder feeds the reconstructed coefficients from scaling unit 805 and transform parameter in the residual parameter (i.e. transform parameter in output of transform unit 208 in the aforementioned encoder) into transform unit 806. Specially, if the residual parameter indicates to skip scaling in decoding a block, the decoder guides the coefficients in the residual parameter to transform unit 806 by bypassing scaling unit 805. Specially, when picture_region_not_skip_flag equal to 0, the decoder bypasses scaling unit 805.

Transform unit 806 performs transform operations on the input coefficients following a transform process specifies in a standard. Transform matrix used in transform unit 806 is the same as that used in inverse transform unit 211 in the aforementioned encoder. Output of transform unit 806 is a reconstructed residual of the decoding block. Specially, when picture_region_not_skip_flag equal to 0, the decoder bypasses scaling unit 806, and sets reconstructed residual of a decoding block in the picture region (with picture_region_not_skip_flag equal to 0) equal to 0.

Generally, since only decoding process is specified in a standard, from the perspective view of a video coding standard, process and related matrix in decoding process is specified as “transform process” and “transform matrix” in a standard text. Thus, in this disclosure, the description on the decoder names the unit implementing a transform process specified in a standard text as “transform unit” to coincide with the standard. However, this unit can always be named as “inverse transform unit” based on the consideration of taking decoding process as an inverse process of encoding.

Adder 807 takes the reconstructed residual in output of transform unit 806 and the prediction samples in output of prediction unit 802 as input data, calculates reconstructed samples of the decoding block. Adder 807 stores the reconstructed samples into a picture buffer. For example, the decoder allocates a picture buffer to (temporally) store output data of adder 807. Another method for the decoder is to reserve a special picture buffer in DPB 809 to keep the data from adder 807.

The decoder passes filtering parameter from parsing unit 801 to filtering unit 808. The filtering parameter for filtering 808 is identical to the filtering parameter in the output of filtering unit 213 in the aforementioned encoder. The filtering parameter includes indication information of one or more filters to be used, filter coefficients and filtering control parameter. Filtering unit 808 performs filtering process using the filtering parameter on reconstructed samples of a picture stored in decoded picture buffer and outputs a decoded picture. Filtering unit 808 may consist of one filter or several cascading filters. For example, according to H.265/HEVC standard, filtering unit is composed of two cascading filters, i.e. deblocking filter and sample adaptive offset (SAO) filter. Filtering unit 808 may include adaptive loop filter (ALF). Filtering unit 808 may also include neural network filters. Filtering unit 808 may start filtering reconstructed samples of a picture when reconstructed samples of all coding blocks in the picture have been stored in decoded picture buffer, which can be referred to as “picture layer filtering”. Optionally, an alternative implementation (referred to as “block layer filtering”) of picture layer filtering for filtering unit 808 is to start filtering reconstructed samples of a coding block in a picture if the reconstructed samples are not used as reference in decoding all successive coding blocks in the picture. Block layer filtering does not require filtering unit 808 to hold filtering operations until all reconstructed samples of a picture are available, and thus saves time delay among threads in a decoder.

The decoder stores the decoded picture outputted by filtering unit 808 in DPB 809. In addition, the decoder may perform one or more control operations on pictures in DPB 809 according to one or more instructions outputted by parsing unit 801, for example, the time length of a picture storing in DPB 809, outputting a picture from DPB 809, and etc.

### Embodiment 3

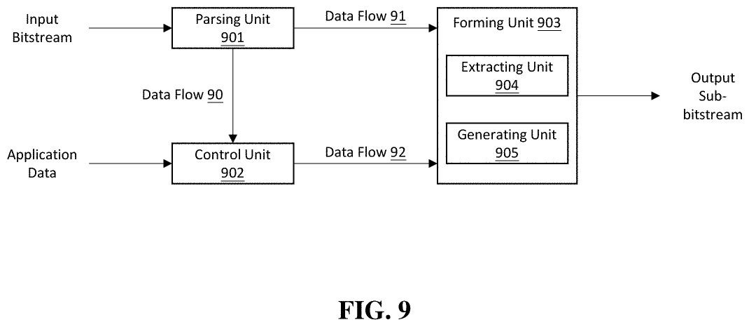

FIG. 9 is a diagram illustrating an example of an extractor that implements the methods in this disclosure. One of the inputs of the extractor is a bitstream generated by the aforementioned encoder in FIG. 2. Another input of the extractor is application data which indicates one or more target picture regions for extraction. Output of the extractor is a sub-bitstream which can be decodable by the aforementioned decoder in FIG. 8. This sub-bitstream, if further extractable, can also be an input bitstream of an extractor.

The basic function of an extractor is to form a sub-bitstream from an original bitstream. For example, a user selected a region in a high resolution video for displaying this region on his smartphone, and the smartphone sends application data to a remote device (e.g. a remote server) or an internal processing unit (e.g. a software procedure installed on this smartphone) to request for media data corresponding to the selected region (i.e. target picture region). An extractor (or equivalent processing unit) on the remote device or the internal processing unit extracts a sub-bitstream corresponding to the target picture region from a bitstream corresponding to the original high resolution video. Another example is that an HMD (Head Mounted Device) detects a current viewport of a viewer and requests for media data for rendering this viewport. Similar to the previous example, the HMD also generates application data indicating a region in a video picture covering the final rendering region of the detected viewport (i.e. target picture region), and sends the application data to a remote device or its internal processing unit. An extractor (or equivalent processing unit) on the remote device or the internal processing unit extracts a sub-bitstream corresponding to the target picture region from a bitstream corresponding to the video covering the rendering viewport.

In this embodiment, an example input bitstream is a bitstream generated by the aforementioned encoder by encoding a 360 degree omnidirectional video using cubemap projection. Partitioning of a projected picture into picture regions is illustrated in FIG. 6. Picture 60 is partitioned into 24 picture regions, wherein a picture region can be a tile group or a tile. Picture regions 600, 601, 606 and 607 correspond to a first surface of cubemap, 602, 603, 608 and 609 correspond to a second surface, 604, 605, 610 and 611 correspond to a third surface, 612, 613, 618 and 619 correspond to a fourth surface, 614, 615, 620 and 621 correspond to a fifth surface, and 616, 617, 622 and 623 correspond to a sixth surface.

When viewport based streaming is used, to rendering a content at a viewport illustrated in FIG. 5, picture regions 600, 603, 606, 609, 610, 611, 612, 613, 614, 615, 620 and 621 will be employed for rendering, while the other picture regions (marked in gray in FIG. 6) are not required for rendering.

Parsing unit 901 parses the input bitstream to obtain a picture region parameter from one or more data units (for example, a parameter set data unit) in the input bitstream. The picture region parameter indicates a partitioning of a picture into picture regions as illustrated in FIG. 6. Parsing unit 901 puts the picture region parameter and other necessary data for determining the target picture regions for extraction (e.g. picture width and height) in data flow 90 and sends data flow 90 to control unit 902.

Note that data flow in this disclosure refers to input parameters and returning parameters of a function in software implementations, data transmission on a bus and data sharing among storage units (also including data sharing among registers) in hardware implementations.

Parsing unit 901 also parses the input bitstream and forwards other data to forming unit 903 via data flow 91 in the process of generating a sub-bitstream when necessary. Parsing unit 901 also includes the input bitstream in data flow 91.

Control unit 802 obtains a target picture region from its input of application data, including location and size of the target picture region in a picture. Control unit 902 obtains the picture region parameter and the width and height of a picture from data flow 90. Control unit 902 determine the addresses and sizes of picture regions located in the target picture region according to the picture region parameter. In this example, control unit 902 determines that the target picture region contains picture regions 600, 603, 606, 609, 610, 611, 612, 613, 614, 615, 620 and 621. Control unit 902 puts a target picture region parameter indicating the above picture regions (e.g. an address of a picture region in the target picture region) in data flow 92.

Forming unit 903 receives data flow 91 and 92, extracts data units corresponding to the picture regions in the target picture region from the input bitstream forwarded in data flow 91. And generates new data units for the picture regions outside the target picture region. Forming unit 903 includes extracting unit 904 and generating unit 905. When extracting unit 904 detects a data unit of a picture region in the target picture region (e.g. according to an address of the picture region), extracting unit 904 extracts the data unit. Take FIG. 6 for example. Extracting unit 904 extracts data units of picture regions 600, 603, 606, 609, 610, 611, 612, 613, 614, 615, 620 and 621 to form a sub-bitstream.

Generating unit 905 generates new data units for the picture regions outside the target picture region and inserts the new data units into the sub-bitstream. Generating unit 905 sets the value of picture_region_not_skip_flag in FIG. 7B for picture regions outside the target picture region equal to 0. Generating unit 905 inserts the new data units in a same access unit in the bitstream containing the data units of the picture regions in the target picture region. According to the syntax structure in FIG. 7, generating unit 905 does not generate bits of a coding block in a picture region outside the target picture region. That is, no bits of a coding block in this picture region outside the target picture region exist in the sub-bitstream.

Forming unit 903 appends the parameter sets from the input bitstream in data flow 91 (as well as other associated data units) to the sub-bitstream according to a specified bitstream structure of the video coding standard. Output of forming unit 903 is the sub-bitstream, which is decodable by the aforementioned decoder in FIG. 8.

Moreover, as the sub-bitstream in this example contains more than one picture regions, the sub-bitstream is still extractable and can be an input of the extractor with a target picture region set covering a smaller viewport.

No rearranging operations as using the frame-based approach are needed in this extractor. Geometry mapping relationship between projected picture and a sphere of a 360 degree omnidirectional video for rendering is kept unchanged after extraction. A server containing this extractor gets rid of generating and sending extra metadata specifying the rearranging locations for frame-based approach, which also saves the extra transmission bandwidth consumed by sending the metadata. A user device does not need to be equipped with an ability, as well as extra storage resources, to process such metadata and to remap picture regions in the packed frame by the frame-based approach to get the geometry mapping relationship for rendering.

### Embodiment 4

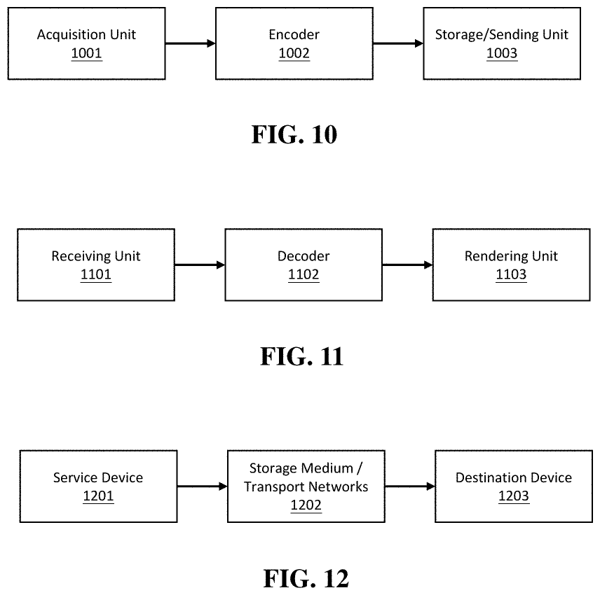

FIG. 10 is a diagram illustrating a first example device containing at least the example video encoder or picture encoder as illustrated in FIG. 2.

Acquisition unit 1001 captures video and picture. Acquisition unit 1001 may be equipped with one or more cameras for shooting a video or a picture of nature scene. Optionally, acquisition unit 1001 may be implemented with a camera to get depth video or depth picture. Optionally, acquisition unit 1001 may include a component of an infrared camera. Optionally, acquisition unit 1001 may be configured with a remote sensing camera. Acquisition unit 1001 may also be an apparatus or a device of generating a video or a picture by scanning an object using radiation.

Optionally, acquisition unit 1001 may perform pre-processing on video or picture, for example, automatic white balance, automatic focusing, automatic exposure, backlight compensation, sharpening, denoising, stitching, up-sampling/down sampling, frame-rate conversion, virtual view synthesis, and etc.

Acquisition unit 1001 may also receive a video or picture from another device or processing unit. For example, acquisition unit 1001 can be a component unit in a transcoder. The transcoder feeds one or more decoded (or partial decoded) pictures to acquisition unit 1001. Another example is that acquisition unit 1001 get a video or picture from another device via a data link to that device.

Note that acquisition unit 1001 may be used to capture other media information besides video and picture, for example, audio signal. Acquisition unit 1001 may also receive artificial information, for example, character, text, computer-generated video or picture, and etc.

Encoder 1002 is an implementation of the example encoder illustrated in FIG. 2 or the source device in FIG. 9. Input of encoder 1002 is the video or picture outputted by acquisition unit 1001. Encoder 1002 encodes the video or picture and outputs generated a video or picture bitstream.

Storage/Sending unit 1003 receives the video or picture bitstream from encoder 1002, and performs system layer processing on the bitstream. For example, storage/sending unit 1003 encapsulates the bitstream according to transport standard and media file format, for example, e.g. MPEG-2 TS, ISOBMFF, DASH, MMT, and etc. Storage/Sending unit 1003 stores the transport stream or media file obtained after encapsulation in memory or disk of the first example device, or sends the transport stream or media file via wireline or wireless networks.

Note that besides the video or picture bitstream from encoder 1002, input of storage/sending unit 1003 may also include audio, text, image, graphic, and etc. Storage/sending unit 1003 generates a transport or media file by encapsulating such different types of media bitstreams.

The first example device described in this embodiment can be a device capable of generating or processing a video (or picture) bitstream in applications of video communication, for example, mobile phone, computer, media server, portable mobile terminal, digital camera, broadcasting device, CDN (content distribution network) device, surveillance camera, video conference device, and etc.

### Embodiment 5

FIG. 11 is a diagram illustrating a second example device containing at least the example video decoder or picture decoder as illustrated in FIG. 8.

Receiving unit 1101 receives video or picture bitstream by obtaining bitstream from wireline or wireless network, by reading memory or disk in an electronic device, or by fetching data from other device via a data link.

Input of receiving unit 1101 may also include transport stream or media file containing video or picture bitstream. Receiving unit 1101 extracts video or picture bitstream from transport stream or media file according to specification of transport or media file format.

Receiving unit 1101 outputs and passes video or picture bitstream to decoder 1102. Note that besides video or picture bitstream, output of receiving unit 1101 may also include audio bitstream, character, text, image, graphic and etc. Receiving unit 1101 passes the output to corresponding processing units in the second example device. For example, receiving unit 1101 passes the output audio bitstream to audio decoder in this device.

Decoder 1102 is an implementation of the example decoder illustrated in FIG. 8. Input of encoder 1102 is the video or picture bitstream outputted by receiving unit 1101. Decoder 1102 decodes the video or picture bitstream and outputs decoded video or picture.

Rendering unit 1103 receives the decoded video or picture from decoder 1102. Rendering unit 1103 presents the decoded video or picture to viewer. Rendering unit 1103 may be a component of the second example device, for example, a screen. Rendering unit 1103 may also be a separate device from the second example device with a data link to the second example device, for example, projector, monitor, TV set, and etc. Optionally, rendering 1103 performs post-processing on the decoded video or picture before presenting it to viewer, for example, automatic white balance, automatic focusing, automatic exposure, backlight compensation, sharpening, denoising, stitching, up-sampling/down sampling, frame-rate conversion, virtual view synthesis, and etc.

Note that besides decoded video or picture, input of rendering unit 1103 can be other media data from one or more units of the second example device, for example, audio, character, text, image, graphic, and etc. Input of rendering unit 1103 may also include artificial data, for example, lines and marks drawn by a local teacher on slides for attracting attention in remote education application. Rendering unit 1103 composes the different types of media together and then presented the composition to viewer.

The second example device described in this embodiment can be a device capable of decoding or processing a video (or picture) bitstream in applications of video communication, for example, mobile phone, computer, set-top box, TV set, HMD, monitor, media server, portable mobile terminal, digital camera, broadcasting device, CDN (content distribution network) device, surveillance, video conference device, and etc.

### Embodiment 6

FIG. 12 is a diagram illustrating an electronic system containing the first example device in FIG. 10 and the second example device in FIG. 11.

Service device 1201 is the first example device in FIG. 10.

Storage medium/transport networks 1202 may include internal memory resource of a device or electronic system, external memory resource that is accessible via a data link, data transmission network consisting of wireline and/or wireless networks. Storage medium/transport networks 1202 provides storage resource or data transmission network for storage/sending unit 1203 in service device 1201.

Destination device 1203 is the second example device in FIG. 11. Receiving unit 1201 in destination device 1203 receives a video or picture bitstream, a transport stream containing video or picture bitstream or a media file containing video or picture bitstream from storage medium/transport networks 1202.

The electronic system described in this embodiment can be a device or system capable of generating, storing or transporting, and decoding a video (or picture) bitstream in applications of video communication, for example, mobile phone, computer, IPTV systems, OTT systems, multimedia systems on Internet, digital TV broadcasting system, video surveillance system, potable mobile terminal, digital camera, video conference systems, and etc.

In an embodiment, specific examples in the embodiment may refer to examples described in the abovementioned embodiments and exemplary implementation methods, and will not be elaborated in the embodiment.

Obviously, those skilled in the art should know that each module or each act of the present disclosure may be implemented by a universal computing apparatus, and the modules or acts may be concentrated on a single computing apparatus or distributed on a network formed by multiple computing apparatuses, and may optionally be implemented by program codes executable for the computing apparatuses, so that the modules or acts may be stored in a storage apparatus for execution with the computing apparatuses, the shown or described acts may be executed in sequences different from those shown or described here in some circumstances, or may form each integrated circuit module respectively, or multiple modules or acts therein may form a single integrated circuit module for implementation. As a consequence, the present disclosure is not limited to any specific hardware and software combination.

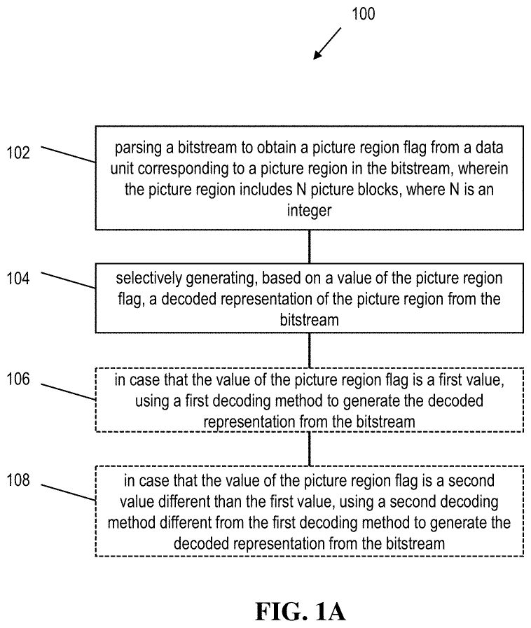

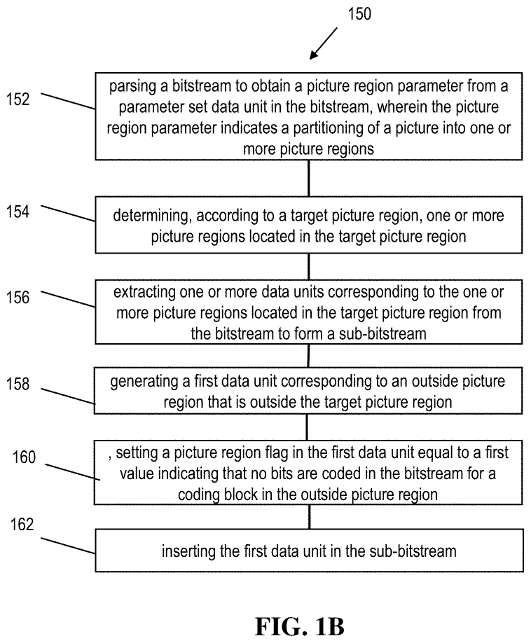

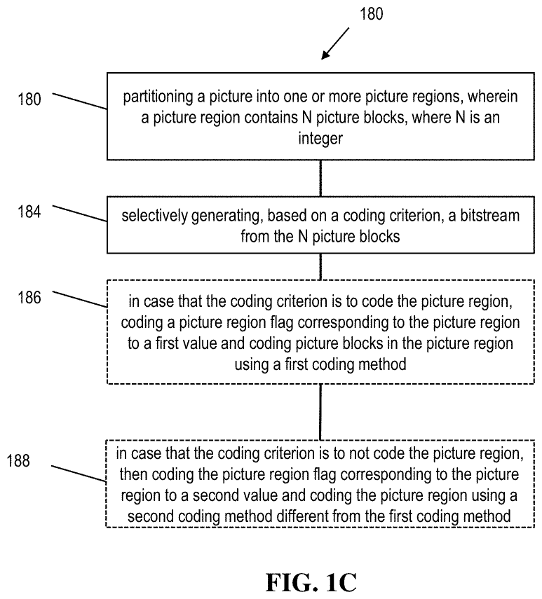

FIG. 1A is a flowchart for an example method 100 of bitstream processing. The method 100 includes parsing (102) a bitstream to obtain a picture region flag from a data unit corresponding to a picture region in the bitstream, wherein the picture region includes N picture blocks, where N is an integer; and selectively generating (104), based on a value of the picture region flag, a decoded representation of the picture region from the bitstream. The selectively generating step includes: in case that the value of the picture region flag is a first value, using a first decoding method to generate the decoded representation from the bitstream (106); and in case that the value of the picture region flag is a second value that is different from the first value, using a second decoding method different from the first decoding method to generate the decoded representation from the bitstream (108). The number of picture blocks N may be greater than one. For example, the method 100 may be able to efficiently decode multiple picture blocks (e.g., coding units CU).

The method 100 may be performed by a device as described with respect to FIG. 11. Such a device may be included as a part of a user device such as a smartphone, a computer, a tablet, or any other device capable of processing or displaying digital video content.

In some embodiments, the type of picture region may be indicated to be inter prediction encoded region. Inter prediction may include uni-directional (forward or predictive) prediction or bi-directional prediction (forward and backward). In such a case, the second decoding method may include setting values of pixels in the picture region equal to values of co-located pixels in a reference picture of the picture region.

In some embodiments, a type of the picture region indicates inter prediction and a reference picture does not exists, and wherein the second decoding method includes setting values of pixels in the picture region equal to a predetermined value.

In some embodiments, a type of the picture region indicates intra prediction, and wherein the second decoding method includes setting values of pixels in the picture region to predetermined values.

In some embodiments, the first decoding method includes using intra decoding or inter decoding of corresponding bits from the bitstream.

In some embodiments, the picture region may include picture blocks that are coded using different coding techniques. For example, a first picture block in the picture region is coded using a coding mode that is different from that of a second picture block in the picture region. Here, the coding mode may be, for example, an inter-prediction coding mode or an intra-prediction coding mode.

FIG. 1B is a flowchart for a method 150 of visual information processing is disclosed. The method 150 includes parsing (152) a bitstream to obtain a picture region parameter from a parameter set data unit in the bitstream, wherein the picture region parameter indicates a partitioning of a picture into one or more picture regions; determining (154), according to a target picture region, one or more picture regions located in the target picture region; extracting (156) one or more data units corresponding to the one or more picture regions located in the target picture region from the bitstream to form a sub-bitstream; generating (158) a first data unit corresponding to an outside picture region that is outside the target picture region, and setting (160) a picture region flag in the first data unit equal to a first value indicating that no bits are coded in the bitstream for a coding block in the outside picture region; and inserting (162) the first data unit in the sub-bitstream.

The method 150 may be implemented by a device as described with respect to FIG. 10. The device may be implemented in a smartphone, a laptop, a computer, or another device used for encoding video.

In some embodiments, the one or more picture regions include non-rectangular picture regions. In some embodiments, the target picture region is based on a user viewport. In some embodiments, the outside picture region corresponds to a picture area that is outside an area visible to a user viewport.

With respect to the methods 100, 150, the partition unit 202 may be used to for the step of parsing the bitstream (102 or 152). Embodiment 3, described in the present document, also may be used to implement the parsing steps to extract picture region parameters and extracting data units from the bitstream and generating the first data unit.

FIG. 1C is a flowchart for an example method 180 for processing a video or a picture to generate a corresponding encoded or compressed domain bitstream representation.

The method 180 may be implemented by a device as described with respect to FIG. 10. The device may be implemented in a smartphone, a laptop, a computer, or another device used for encoding video.

The method 180 includes partitioning (182) a picture into one or more picture regions, wherein a picture region contains N picture blocks, where N is an integer, selectively generating (184), based on a coding criterion, a bitstream from the N picture blocks. The the selectively generating (184) includes in case that the coding criterion is to code the picture region, coding a picture region flag corresponding to the picture region to a first value and coding picture blocks in the picture region using a first coding method (186), and in case that the coding criterion is to not code the picture region, then coding the picture region flag corresponding to the picture region to a second value and coding the picture region using a second coding method different from the first coding method (188).

For example, the partition unit 202 may be used to perform the partitioning step 182 and steps 184, 186 or 188. For example, the entropy coding unit 215 may be used to code the picture region flag in the bitstream.

In various embodiments the first and the second coding methods may include intra coding or predictive coding (uni- or bi-directional). In some embodiments, the picture region may include multiple picture blocks (e.g., N is greater than 1). As described with respect to FIG. 5, a user's viewpoint may be used in deciding how and which picture blocks to code during implementation of the method 180.

In FIGS. 1A and 1C, the steps 106, 108, 186, 188 are shown with dashed outlines because, according to some embodiments, for encoding or decoding of a specific picture region, only one of these two steps will be implemented. In general, during the coding or decoding operation of video, one or the other step will be implemented, for example, depending on content details. However, it is also possible that some regions of a video or image may be encoded without using either the coding technique described with respect to FIGS. 1A-1C.

In some embodiments, a video encoder apparatus may include a processor that is configured to implement the method 180. The processor may include, or may control and use, special-purpose video encoding circuitry that is configured for performing functions such as those described with respect to FIG. 2.

In some embodiments, a video decoding or transcoding device may be used to implement the methods 100 or 150. The device described with respect to FIG. 8 may be used for implementation.

It will be appreciated that the techniques described in the present document may be incorporated within a video encoder apparatus or a video decoder apparatus to significantly improve the performance of the operation of encoding video or decoding video. For example, some video applications such as virtual reality experience or gaming require real-time (or faster than real-time) encoding or decoding of video to provide satisfactory user experience. The disclosed technique improve the performance such applications by using the picture-region based coding or decoding techniques as described herein. For example, coding or decoding of less-than-all portion of a video frame based on a user's viewpoint allows for selectively coding only video that will be viewed by the user. Furthermore, the reorganizing of picture blocks to create picture regions in a rectangular video frame allows for the use of standard rectangular-frame based video coding tools such as motion search, transformation and quantization.

The above is only the preferred embodiment of the present disclosure and not intended to limit the present disclosure. For those skilled in the art, the present disclosure may have various modifications and variations. Any modifications, equivalent replacements, improvements and the like made within the principle of the present disclosure shall fall within the scope of protection defined by the appended claims of the present disclosure.

### INDUSTRIAL APPLICABILITY

From the above description, it can be known that the problem of extra computational burden of viewport based streaming in the related art is solved, and further achieved are the effects of effective coding a picture region that is skipped in coding. All the drawbacks in the existing methods are solved by using the aforementioned encoder to generate an original bitstream, the extractor in this example implementation to obtain a sub-bitstream and the aforementioned decoder to decode the bitstream (as well as the sub-bitstream).

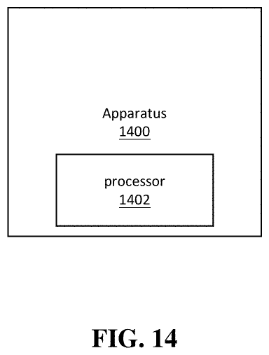

FIG. 14 shows an example apparatus 1400 that may be used to implement encoder-side or decoder-side techniques described in the present document. The apparatus 1400 includes a processor 1402 that may be configured to perform the encoder-side or decoder-side techniques or both. The apparatus 1400 may also include a memory (not shown) for storing processor-executable instructions and for storing the video bitstream and/or display data. The apparatus 1400 may include video processing circuitry (not shown), such as transform circuits, arithmetic coding/decoding circuits, look-up table based data coding techniques and so on. The video processing circuitry may be partly included in the processor and/or partly in other dedicated circuitry such as graphics processors, field programmable gate arrays (FPGAs) and so on.

The Apparatus

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed is:

1. A method of bitstream processing, comprising:
parsing a bitstream to obtain a picture region flag from a data unit corresponding to a picture region in the bitstream, wherein the picture region includes N picture blocks, where N is an integer; and
selectively generating, based on a value of the picture region flag, a decoded representation of the picture region from the bitstream;
wherein the selectively generating includes:
in case that the value of the picture region flag is a first value, using a first decoding method to generate the decoded representation from the bitstream; and
in case that the value of the picture region flag is a second value different from the first value, using a second decoding method different from the first decoding method to generate the decoded representation from the bitstream.

2. The method of claim 1, wherein a type of the picture region indicates inter prediction and wherein the second decoding method includes setting values of pixels in the picture region equal to values of co-located pixels in a reference picture of the picture region.

3. The method of claim 1, wherein a type of the picture region indicates inter prediction and a reference picture does not exists, and wherein the second decoding method includes setting values of pixels in the picture region equal to a predetermined value.

4. The method of claim 1, wherein a type of the picture region indicates intra prediction, and wherein the second decoding method includes setting values of pixels in the picture region to predetermined values.

5. The method of claim 1, wherein the first decoding method includes using intra decoding or inter decoding of corresponding bits from the bitstream.

6. The method of claim 1, wherein N is greater than 1.

7. The method of claim 6, wherein a first picture block in the picture region is coded using a coding mode that is different from that of a second picture block in the picture region, wherein the coding mode is an inter-prediction coding mode or an intra-prediction coding mode.

8. A visual information processing method, comprising:
parsing a bitstream to obtain a picture region parameter from a parameter set data unit in the bitstream, wherein the picture region parameter indicates a partitioning of a picture into one or more picture regions;
determining, according to a target picture region, one or more picture regions located in the target picture region;
extracting one or more data units corresponding to the one or more picture regions located in the target picture region from the bitstream to form a sub-bitstream;
generating a first data unit corresponding to an outside picture region that is outside the target picture region, and setting a picture region flag in the first data unit equal to a first value indicating that no bits are coded in the bitstream for a coding block in the outside picture region; and
inserting the first data unit in the sub-bitstream.

9. The method of claim 8, wherein the one or more picture regions include non-rectangular picture regions.

10. The method of claim 8, wherein the target picture region is based on a user viewport.

11. The method of any of claim 8, wherein the outside picture region corresponds to a picture area that is outside an area visible to a user viewport.

12. An encoding method for processing a video or a picture, including:
partitioning a picture into one or more picture regions, wherein a picture region contains N picture blocks, where N is an integer;
selectively generating, based on a coding criterion, a bitstream from the N picture blocks,
wherein the selectively generating includes:
in case that the coding criterion is to code the picture region, coding a picture region flag corresponding to the picture region to a first value and coding picture blocks in the picture region using a first coding method; and
in case that the coding criterion is to not code the picture region, then coding the picture region flag corresponding to the picture region to a second value and coding the picture region using a second coding method different from the first coding method.

13. The method of claim 12, wherein the first coding method includes intra coding.

14. The method of claim 12, wherein the second coding method includes predictive coding.

15. The method of claim 12, wherein the first coding method codes the N picture blocks and writes a coding bit of the N picture blocks into a bitstream.

16. The method of claim 12, wherein the second coding method skips coding the N picture blocks and writing a coding bit of the N pictures blocks into a bitstream.

17. The method of any of claim 12, wherein N is greater than 1.

18. The method of any of claim 12, wherein the coding criterion is dependent on a current viewport information of the picture.
